(19) United States
(12) Patent Application Publication
(10) Pub. No.: US 2012/0282369 A1
(43) Pub. Date: Nov. 8, 2012

(54) METHOD FOR INCREASING THE NUTRITIONAL VALUE OF RAPESEED AND RAPE PRODUCTS WITH DECREASED OIL CONTENT

(76) Inventors: József Pandur, Erd (HU); Imre Fekete, Szazhalombatta (HU); Zoltán Bakos, Szada (HU)

(21) Appl. No.: 13/456,401

(22) Filed: Apr. 26, 2012

(30) Foreign Application Priority Data
May 2, 2011 (HU) P1100226
Jun. 22, 2011 (EP) 11170890.5

(51) Int. Cl. A23K 1/18; A23K 1/00

(52) U.S. Cl. 426/2; 426/635

(57) ABSTRACT

The invention relates to a method for treating rapeseed or a rape product remaining after the partial or complete recovery of the oil content of rapeseed, which method comprise the step of contacting the rapeseed or the rape product or its mixture formed with one or more other feeds, with an intercalation complex of an element belonging to the main group 2 or 3 of the periodic table formed with an anion and one or more polymers.

The invention also relates to a rapeseed or a rape product which can be produced by the above method, as well as to the mixture thereof with one or more other feeds, and to the use thereof.

The invention relates to a method for treating rapeseed or rape products to increase their nutritional value.

The nutritional value of rape (Brassica napus) depends on its antinutritive substances. In rape products the amount of antinutritive erucic acid, tannic acid (tannin) and glucosinolate (mustard oil glucoside) fundamentally determines the feed intake and nutrient utilization efficiency of animals. Recently the erucic acid content of the “00” rape developed by plant breeding processes is so low (generally lower than 1 percent) that its nutrition physiological effect is negligible. Similarly to erucic acid, the tannic acid content of rapeseed can also be decreased significantly.

The glucosinolate concentration in currently grown cultivars is generally lower than 25 mmol/kg, which increases 1.5-fold in rape products (rapeseed grits or pellet) used for animal feeding after oil recovery. However, there may be significant differences in the glucosinolate content of various hybrids and cultivars. The glucosinolate content is expressed as sinigrin-equivalent, whose determination method is described by Hungarian Standard MSZ EN ISO 9167-1.

Glucosinolates have a goitrogenic effect, which is exerted indirectly. As the majority of iodine is found bound to tyrosine and plays an important role in carbohydrate metabolism, the proper quantity of iodine intake is essential for all animals. The indirect effect of goitrogenic substances, which can be found in high levels in crucifers, means that they can cause secondary iodine deficiency. Tannin, which makes the flavour of rapeseed grits displeasing, can substantially be classified as a glucoside, because in its molecule five gallic acid moieties are connected to one glucose moiety. Tanner's bark powder containing high quantity of tannin has been also used to treat diarrhea and enteritis (another ancient application is tanning).

As described in Horn, A., Keserl, J., Szentmihályi, S. (editors): Állattenyésztésztésünk fejlesztésének lehetöségei (Possibilities in Development of Stock-breeding) Mezögazdasági Kladó Budapest, 1982, extracted rapeseed grits having loss glucosinolate content can be fed without detrimental effects in the amounts as given in the following table:

| | Percentage of extracted rapeseed |
|---|---|
| Livestock/feed | grits [%] |
| Breeding and commodity hen feeds | 3.0-5.5 |
| Goose fattening | 3 |
| Lactating, sow | 2 |
| Calf grower | 5 |
| Dairy cow feed | 9-12 |
| Young calf | 12.8-14.0 |
| Beef cattle | 10 |
| Sheep feeds | 3-5 |

According to recent experimental results [Atle M. Bones, John T. Rossiter: Phytochemistry 67 (2006) 1053-1067] plants that contain glycoside become poisonous when the enzyme myrosinase releases the glycan moiety from the glycosidic bond. Isothiocanates, oxazolidones, nitriles and epithionitrils formed in the process are toxic [Galletti, S. et al., Soil Biology and Biochemistry, 30 (2008) 1-4]. Therefore, preconditioning methods (such as pulping, soaking) with similar effects (i.e. causing hydrolysis) will facilitate intoxication. The biological activity of decomposition products formed by barium chloride or silver nitrate treatment in alkaline (KOH, ammonia {GB2113970, CN1341851, CN101037448}, barium hydroxide) or aqueous suspensions can decrease the nutritional value of rape products [Fenwick, G. R., Heaney, R. K., Gmelin, R., Rakow, D., Thies, W., Glucosinalbin in Brassica napus—a re-evaluation. Zeitschrift fuer Pflanzenzuechtung 87, 254-259 (1980)].

Intensive heat treatment will reduce the rate of toxicity by inactivating the usually heat-sensitive myrosinase (EP 0534573). K. Oerlemans and coworkers [K. Oerlemans et al. Food Chemistry 95 (2006) 19-29] have measured 30-99 percent (depending on the chemical structure) degradation of glucosinolates after boiling at 120° C. for 40 minutes.

| Process | Reference |
|---|---|
| 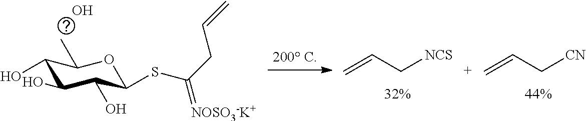 | Atle M. Bones a. John T. Rossiter: Phytochemistry 67 (2006) 1053-1067 |
| 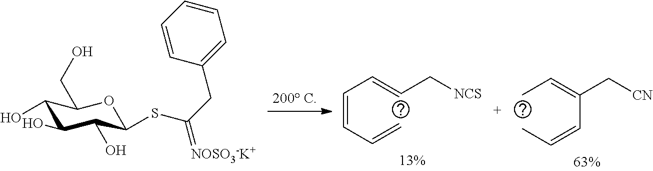 | K. Oerlemans et al.: Food Chemistry 95 (2006) 19-29 |

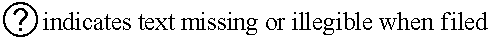

Szelényiné et al. [Szelényiné Galántai marianne, Votisky Lászlóné, Dinnyés Lászlóné, Jécsai Györgyné. “Állattenyésztés és Takarmányozás” (Stock-breeding and Feeding) 39. (4) 369-79 (1990)] have supplemented a high (98-128 mmol/kg) glucosinolate content swine feed containing 10% extracted rapeseed grits and 5% extracted soybean grits complemented with 1 mg/kg potassium iodide (KI). 150 mg/kg zinc chloride and 250 mg/kg copper sulphate as microelements. During the feeding trial they observed that protein utilization increased by 27 percent as compared to the diet fed without any complements.

A significant part of poultry feeds is constituted by soybean grits, which advantageously supplements the amino acid repertoire of cereals. However, soybean grits is an expensive feed and can be purchased almost exclusively from the American continent. The demand for lower feeding costs and produce economical products has led to the experimental investigation of using cheaper protein containing feeds, such as rapeseed grits, for the partial substitution of soybean grits in poultry feeding.

Halmágyiné et al. [Halmágyiné Valter, T., Gippert, T., Hullar, I (1993) “Állattenyésztés és Takarmányozás” (Stock-breeding and Feeding), 42. I. 65-78.] in their first experiment fed a fodder containing 10, 15 and 20 percent of rapeseed grits, while in their second experiment they fed a fodder containing 4, 8 and 12 percent of cold pressed rapeseed. After analyzing the results they came to the conclusion that whole rapeseed and cold pressed rapeseed are energy rich feeds which, beside protein supplementation, can be used to increase the energy content of broiler feeds. Chicken can digest the crude protein content of various rape products weaker than that of soybean grits. From among rape products the nutritives of extracted rapeseed grits have the best digestibility, slightly weaker is that of the cold pressed product, while the whole (full fat) rapeseed is the least digestible for poultry. According to their experimental results in broiler feed, pressed “00” rapeseed can be used in an amount of 4 to 8 percent for the partial protein-proportional substitution of soybean grits and for increasing the energy content of broiler's feeds. According to their observations, using a 12 percent dose will significantly worsen the body mass increase

The disadvantages of the above described methods for decreasing glucosinolate content are the following:

because of the cost of the intervention, chemical soaking treatments and dry or wet heat treatment, will significantly increase the price of the product used for feeding:

the concentration of copper used in microelement treatment significantly exceeds the rate permitted for animal feeding of 15-175 mg/kg referred to dry matter {as regulated in Regulation (EC) No. 1831/2003 [and in the FVM (Ministry of Agriculture and Rural Development) decree No. 44/2003. (IV. 26.) as deduced therefrom]}.

The object of the invention is to develop a method for decreasing the antinutritive effect of glucosinolate in rapeseed or rape products remaining after the partial or complete recovers of the oil content of rapeseed, which method is free from the above mentioned disadvantages.

The invention is based on the unexpected finding that if rapeseed or a rape product remaining after the partial or complete recovery of the oil content of rapeseed is treated with an intercalation complex of an element belonging to the main group 2 or 3 of the periodic table with an anion and polymers, the glucosinolate-type substances will undergo a chemical conversion, the result of which is that the formed compounds are absorbed to a lesser degree than the level which would cause pathologic changes, and the rate of using the treated rape products solely depends on their nutritive value.

Therefore, the subject of the invention is a method for treating rapeseed or a rape product remaining after the partial or complete recovery of the oil content of rapeseed, which method comprises the step of contacting the rapeseed or the rape product or its mixture formed with one or more other feeds with an intercalation complex of an element belonging to the main group 2 or 3 of the periodic table with an anion and one or more polymers.

The rapeseed or rape product treated by the method of the invention max be used alone or in combination with common feeds (and optionally with premixes and/or additives) to feed animals.

The method of the invention is useful for treating rapeseed as such and/or a rape product with reduced oil content remaining after the partial or complete recovery of the oil content of rapeseed, such as any of a cold or hot pressed and/or extracted cake, pellet or grit or any mixtures thereof in arbitrary ratios. The mixture of the above mentioned rapeseed or rape product with one or more other fodders can also be treated in accordance with the invention.

According to the invention, the treatment is carried out with an intercalation complex of an element belonging to the main group 2 or 3 of the periodic table formed with an anion and one or more polymers.

The components of the intercalation complex used according to the invention include a salt formed by an element belonging to the main group 2 or 3 of the periodic table together with an anion, and any polymer.

The element belonging to the main group 2 or 3 of the periodic table is generally selected from the group comprising Be, Mg, Ca, Sr, Ba, Ra, Sc, Y, La, Ac, B, Al, Ga, In and Tl.

The elements which can be preferably used according to the invention are Al, B, Ba, Ca, Ga, Mg and Sr, in particular Al, B, Ba, Ca and Mg, specifically Al, Ca and Mg.

In the salt of an element belonging to the main group 2 or 3 of the periodic table formed with an anion, those anions are preferred, which have greater reactivity against alkali metals occurring in rapeseed and rape products than against the elements belonging to the main group 2 or 3 of the periodic table.

Examples of such anions include inorganic anions, such as halides and pseudohalides. e.g., Cl, Br, I, SCN and CN, the anions of nitrogen oxoacids, e.g. nitrite and nitrate. The preferred inorganic anions which can be used are halides, such as Cl, Br and I, the anions of nitrogen oxoacids, such as nitrite and nitrate.

Additional examples of applicable anions include organic anions, such as anions which can be derived from aliphatic, alicyclic, aromatic and heteroaromatic carboxylic acids, hydroxycarboxylic acids and oxocarboxylic acids. Aliphatic, alicyclic, aromatic and heteroaromatic carboxylic acids, hydroxycarboxylic acids and oxocarboxylic acids can be exemplified by C₁₋₂₀ aliphatic, alicyclic, aromatic and heteroaromatic carboxylic acids, hydroxycarboxylic acids and oxocarboxylic acids, among which C₁₋₁₀ aliphatic, alicyclic, aromatic and heteroaromatic carboxylic acids, hydroxycarboxylic acids and oxocarboxylic acids can be preferably used.

As organic anions, the anions of Formula (I) can be particularly preferably used

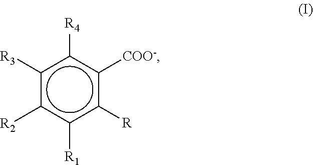

wherein
each of R, R¹, R², R³ and R⁴ independently represents H, OH, SO₃H, NO₂, COOH, halogen, C₁₋₁₀ alkyl, C₁₋₁₀ alkoxy, C₆₋₂₀ aralkoxy optionally substituted with one or more substituents, C₆₋₁₀ aryloxy optionally substituted with one or more substituents, wherein the substituents are individually selected from OH, SO₃H, NO₂, COOH, halogen, C₁₋₁₀ alkyl and C₁₋₁₀ alkoxy.

The anions of Formula (II) can also be preferably used as organic anions

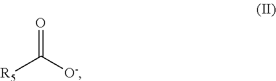

wherein
R⁵ represents H or CR⁶R⁷R⁸, wherein
each of R⁶, R⁷ and R⁸ independently represents H, OH, SO₃H, NO₂, COOH, halogen, C₁₋₂₀ alkyl, C₁₋₂₀ alkoxy, C₆₋₂₀ aralkoxy optionally substituted with one or more substituents, C₆₋₁₀ aryloxy optionally substituted with one or more substituents, wherein the substituents are individually selected from OH, SO₃H, NO₂, COOH, halogen, C₁₋₁₀ alkyl and C₁₋₁₀ alkoxy.

As used herein, “halogen atom” means fluorine, chlorine, bromine or iodine atom, preferably chlorine, bromine or iodine atom.

“C₁₋₁₀ alkyl” refers to a saturated or unsaturated, straight or branched chain hydrocarbon residue comprising from 1 to 10 carbon atoms. Preferred is C₁₋₈ alkyl, particularly C₁₋₆ alkyl, specifically C₁₋₄ alkyl. Examples of C₁₋₁₀ alkyl groups include methyl, ethyl, n- or iso-propyl, n-, iso- or tert-butyl, isomeric pentyl, hexyl, heptyl and octyl groups.

“C₁₋₂₀ alkyl” refers to a saturated or unsaturated, straight or branched chain hydrocarbon residue comprising from 1 to 20 carbon atoms. Among these, preferred are C₁₋₁₈ alkyl groups, particularly C₁₋₁₆ alkyl, especially C₁₋₁₄ alkyl, Examples of C₁₋₂₀ alkyl include methyl, ethyl, n- or isopropyl, n-, iso- or tert-butyl, isomeric pentyl, hexyl, heptyl and octyl groups, as sell as saturated or unsaturated alkyl groups having longer chain length, such as dodecyl, tetradecyl, hexadecyl, octadecyl, 9-octadecenyl, 6,9,12-octadecatrienyl, cis- or trans-5,8,11,14-eicosatetraenyl.

“C₁₋₁₀ alkoxy” refers to any of the above defined C₁₋₁₀ alkyl groups linked through an oxygen atom. Examples of C₁₋₁₀ alkoxy include methoxy, ethoxy, n- or iso-propoxy, n-, iso- or tert-butoxy, isomeric pentoxy, hexoxy, heptoxy and octoxy groups.

“C₁₋₂₀ alkoxy” refers to any of the above defined C₁₋₁₀ alkyl groups linked through an oxygen atom. Examples of C₁₋₁₀ alkoxy include methoxy, ethoxy, n- or iso-propoxy, n-, iso- or tert-butoxy, isomeric pentoxy, hexoxy, heptoxy and octoxy groups, as sell as saturated or unsaturated alkoxy groups having longer chain length, such as dodecyloxy, tetradecyloxy, hexadecyloxy, octadecyloxy, 9-octadecenyloxy, 6,9,12-octadecatrienyloxy, cis- or trans-5,8,11,14-eicosatetraenyloxy.

“C₆₋₂₀ aralkoxy” refers to an aryl group linked through an above defined alkoxy group comprising from 6 to 10 carbon atoms in the aryl moiety and from 1 to 10 carbon atoms in the alkoxy moiety. Examples of C₆₋₂₀ aralkoxy include phenylmethoxy, phenylethoxy, phenylpropoxy, phenybutoxy, phenylpentoxy, naphthlmethoxy, naphthlethoxy, naphthylpropoxy and naphthylbutoxy.

“C₆₋₁₀ aryloxy” refers to an aryl group linked through an oxygen atom comprising from 6 to 10 carbon atoms in the aryl moiety. Examples of C₆₋₂₀ arryloxy include phenyloxy and naphthyloxy.

Preferred examples of the anions of Formula (I) include the anions that can be derived from the following acids: benzoic acid, 2-methylbenzoic acid, 3-chlorobenzoic acid, salicylic acid, acetyl salicylic acid, 2-nitrobenzoic acid, 4-toluenesulfonic acid, mandelic acid, 4-(dodecyloxy)benzoic acid, coumarinic acid, ferulic acid, sinapic acid, gallic acid, trimethoxybenzoic acid, homoveratrumic acid, 2-chloro-5-(trifluoro-methyl)benzoic acid, 2,5-dimethoxy-3-nitrobenzoic acid, 2,6-dichloro-3-nitrobenzoic acid, 2-bromo-5-nitrobenzoic acid, 2-(4-chlorobenzol)benzoic acid, 1-naphtalenesulfonic acid, 8-hydroxy-5,7-dinitro-2-naphtalenesulfonic acid, phthalic acid, terephthalic acid, 4-(trifluoromethyl)phthalic acid, 3-nitrophthalic acid, monomethyl phthalate.

Preferred examples of the anions of Formula (II) include the anions that can be derived from the following acids: formic acid, chloroacetic acid, stearic acid, dichloroacetic acid, bromoacetic acid, trifluoroacetic acid, sulphoacetic acid, 3-nitropropionic acid, 3-hydroxybutyric acid, 3-decloxypropionic acid, succinic acid, malic acid, pantothenic acid, tartaric acid, 2-oxoglutaric acid, glucuronic acid, citric acid, phenylacetic acid, (2-chlorophenylacetic acid, (2-(trifluoromethyl)phenyl)acetic acid, 4-(2-chloropropionyl)phenylacetic acid, 3,4-dimethoxyphenylacetic acid, 4-(benzyloxy)phenylacetic acid, 4-(bromomethyl)phenylacetic acid, mandelic acid, 2,3-dibenzoyltartaric acid, (4-cholorophenoxy)phenylacetic acid, bis(4-chlorophenoxy)acetic acid, EDTA.

Particularly preferred examples of applicable organic anions include the anions that can be derived from the following compounds: formic acid, capronic acid, lactic acid, dichloroacetic acid, sulfoacetic acid, oxalic acid, 2-oxoglutaric acid, succinic acid, malic acid, tartaric acid, citric acid, fumaric acid, maleic acid, fumaric acid monoethyl ester, ethyl malonate, phenylacetic acid, (2-chlorophenyl)acetic acid, 2-nitrobenzoic acid, 4-toluenesulfonic acid, 2,6-dichloro-3-nitrobenzoic acid, 2-bromo-5-nitrobenzoic acid, 2-(4-chlorobenzoyl)benzoic acid, 1-naphtalenesulfonic acid, ferulic acid, sinapic acid, gallic acid, trimethoxybenzoic acid, homocratrumic acid, phthalic acid, terephthalic acid, 4-(trifluoromethyl)phthalic acid, 3-nitrophthalic acid, EDTA.

As metal salts the following compounds can be preferably used: aluminum formate, aluminum formacetate, aluminum citrate, aluminum chloride, aluminum 3-nitropropionate, magnesium benzoate, magnesium bromide, magnesium formate, magnesium caprylate, magnesium chloroacetate, magnesium lactate, magnesium oxalate, magnesium O-acetylsalicylate, calcium acetate, calcium chloroacetate, calcium monoethyltfumarate, calcium glucanate, calcium nitrate, calcium pantothenate, calcium stearate, calcium and magnesium EDTA salt.

As metals salts the ones formed by an anion of organic and inorganic acids, which are stronger than those having a pKₐ value of 4.5 (measured in water) with an element belonging to the main group 2 or 3 of the periodic table can be particularly preferably used. Examples of such metal salts include aluminum formacetate, aluminum chloride, aluminum 3-nitropropionate, magnesium formate, magnesium oxalate, calcium chloroacetate, calcium monoethylfumarate, calcium nitrate.

Metal salts used in accordance with the invention are commercially available and/or can be readily produced by methods known per se.

Any organic poly mer can be used as polymer, such as products prepared by physical treatment (e.g. by grinding or by milling methods known per se) from plant seeds or dried green forage, such as grits, meal, bran, germ, as well as protein and carbohydrate components thereof, preferably products prepared from grains (such as barley, wheat, corn, rye, triticale and the like), oilseeds (such as sunflower seed, soybean, rapeseed and the like), legume seeds (such as pea, lentil), and dried green forage (such as alfalfa and the like), particularly preferrably wheat meal, corn gluten, potato starch, rapeseed grits and alveoli meal.

Any inorganic polymer can also be used as polymers, for example clay minerals, silicates, kaolin and zeolites, preferably aluminum silicate, kaolin and zeolites.

According to the invention, mixtures of organic and inorganic polymers in any ratios can be preferably used. Preferred are mixtures of organic and inorganic polymers in 1:100-100:1 weight ratios, particularly in 1:10-10:1 weight ratios.

Polymers used in accordance with the invention are commercially available and/or can be readily produced by methods known per se.

The weight ratio of the salt of the element belonging to the main group 2 or 3 of the periodic table to the polymer is from 1/100 to 500/100, preferably from 10/100 to 90/100.

The intercalation complex used according to the invention is prepared by the usual methods. Preparation is preferably carried out by mixing a salt of the elements belonging to the main group 2 or 3 of the periodic table with the polymer at ambient temperature, usually at 15-30° C., preferably at 22-25° C.

In the method according to the invention the rapeseed or rape product or the mixture thereof with one or more other feeds is contacted with the said intercalation complex. To accomplish contacting the rapeseed or rape product or the mixture thereof with one or more other feeds is measured with the intercalation complex at ambient temperature, preferably at 15-30° C. particularly preferably at 22-25° C. and blended to homogeneity

Blending can be carried out in an, standard blending apparatus. Preferably, powder blenders, ribbon blenders and screw blenders can be used.

The proposed weight ratio of the intercalation complex to the rapeseed or rape product is usually from 1/10000 to 300/1000, preferably 1-50/1000.

The rapeseed or rape product treated by the method according to the invention is used as such for feeding animals, or processed to animal feed by mixing it with other fodders and optionally with premixes and/or additives commonly used for feeding. For this purpose the fodders, premixes and additives listed and permitted in Regulation (EC) No. 1831/2003 [and in FVM (Ministry of Agriculture and Rural Development) decree No. 44/2003. (IV. 26.) deduced therefrom] are usually used.

As feed component, the products listed in Annex No. 1 and 5 of FVM decree No. 44/2003. (IV. 26.) can be preferably used, among which particularly preferred are corn, wheat, barley, rye, triticale, soy products (e.g. extracted soybean grits), sunflower products (e.g. extracted sunflower seed grits), brewery by-products and the like.

As a premix, the premixes defined in point No. 1(1a-f) of IVM decree No. 44/2003. (IV. 26.) can be preferably used, for example concentrated supplements being added to feeds in amount of 0.5-10 weight %, comprising primarily vitamins, trace elements and minerals, amongst which particularly preferred are E 771. Protavit Minor (a dairy cow concentrate made by Bábolna Feed Ltd.), dairy cow complete mix-microelement premix, hen premix and the like.

As supplements, the supplements suitable for feeding as detailed in Annex No. 1 and 4 of FVM decree No. 44/2003. (IV. 26.) can be preferably used, among which preferred examples are veterinary compositions used for feeding, antioxidants (dodecyl gallate, tocopherol and the like), taste enhancers and appetite booster additives (saccharin, Neohesperidine Dihydrochalcon and the like), excipients, anti-clumping additives and lubricants (calcium stearate, perlite and the like), emulsifiers, stabilizators, filler materials and coagulants (agar-agar, dextran and the like), colouring agents, including pigments (capsanthin, lutein and the like), growth promoters (potassium diformate and the like), preservatives (sodium benzoate, boric acid and the like), minerals (sodium chloride and the like), acidity regulators (calcium hydroxide, dicalcium diphosphate, calcium phosphate, feed lime and the like), trace elements (cobalt, copper and the like), vitamins, pro-vitamins and such substances of similar activity which can be clearly defined chemically (vitamins A and B and the like), water absorbing substances, enzymes (alpha galactosidase, endo-1.3(4)beta-glucanase and the like), microorganisms, radionuclide-binding substances [ferric(III)-ammoniumhexacyanoferrate(II) and the like], products for improving the protein supply of animals and probiotics (L-lysine×HCl, D,L-methionine and the like) or mixtures thereof in any ratio. Particularly preferred examples of the supplements are the vitamins (such as vitamins A, B, C and E) and the salts (such as copper, iron, zinc and manganese salts).

Examples of animals that can be fed with rapeseed or rape product treated by the method according to the invention (or with feeds comprising them) include animals kept for breeding purposes and livestock, as well as wild animals including fish, fowls and mammals. Examples thereof include poultry, such as chickens, hens, ducks, geese and turkeys, as well as mammals, such as swine, sheep, cattle and horses.

Feeding is carried out by dispensing the usual amounts depending on various factors, such as the breed, age and general health condition of the animals. The dispensed amount can be precisely determined by a specialist. The daily teed amount is generally 5-200 g/kg, preferably 50-200 g/kg of body weight for poultry, and generally 1-200 g/kg, preferably 10-200 g/kg of body weight for mammals. Feeding is carried out one or more times a day.

The subject of the invention also includes a rapeseed or rape product treated by the above method and a feed that contains the same.

The advantage according to the method of the invention is that by using it the chemical alteration of the antinutritive glucosinolate-type substances of rapeseed and rape products can be simply and effectively achieved in standard equipments of feed processing plants, without an need for using separate (aqueous, acidic or alkaline) extraction and/or heat treatment (drying) processes. Rapeseed or rape products treated by the method according to the invention can be preferably used to substitute for much more expensive soy and so, products.

The invention is hereafter illustrated by the following examples without limiting the scope of the invention to them. In the following examples “% of DM” refers to percentage of dry matter.

### EXAMPLE 1

The following components are measured to a 20 cm³ screw-cap container: 4.5 g magnesium O-acetxlsalicylate (magnesium content: 16.0%). 1.5 g wheat meal (dry matter: 8.5%, crude protein content: 19.5% of DM) and 1.5 g ground aluminum silicate (dry matter >95%, ion-exchange capacity: 0.6 mol/kg). The container containing the mixture is sealed, then shaken for 10 minutes at 22-25° C. on a “HAAKE SWB” 20 type shaker (n=80/min).

150 g extracted rapeseed grits [glucosinate concentration: 27 mmol/kg (expressed as sinigrin): dry matter: 90.5%, crude protein: 35.5% of DM, crude fat: 2.1% of DM, crude fibre: 14.0% of DM) are measured to a 500 cm³ screw-cap container and the previously prepared powder mixture is added thereto. The container containing the mixture is sealed, then shaken for 10 minutes at 22-25° C. on a shaker (n=80 min).

Using the rapeseed grits treated as described above, a laying hen feed with the following composition is prepared by a method known per se.

Ingredients of 1000 g laying hen feed comprising rapeseed product [g]: corn: 484, extracted soy bean grits: 160, wheat: 100, rapeseed grits treated as detailed above: 150, feed lime: 56.5% hen premix: 50.

The laying hen feed comprising the following ingredients without any rape product was used as a comparative control:

Ingredients of 1000 g “soybean-only” control laying hen feed [g]: corn: 533, extracted soybean grits: 261, wheat: 100, feed lime: 56.5% laying hen premix: 50.

For the “Shaver-576” hybrid laying hens fed ad libitum for 90 days with the above detailed laying hen feed, the egg production yield and the results of organoleptic analysis of the eggs did not show any difference (within the error limit of the measurement method) from that of the control group fed with the feed without any rape product. Measurement results are detailed in Table 1.

### EXAMPLE 2

The method was carried out as described in Example 1 with the difference that 3.0 g aluminum 3-nitropropionate was used instead of magnesium O-acctylsalicylate. 1.0 g alfalfa meal (dry matter: 9.5%, crude protein content: 17.0% of DM) was used instead of wheat meal, and ground aluminum silicate as replaced by 1.0 g zeolite (dry matter >95%, ion-exchange capacity: 0.5 mol/kg). The intercalation complex is admixed with 150 g cold pressed rapeseed grits [glucosinolate concentration: 26 mmol/kg (expressed as sinigrin): dry matter: 90.1%, crude protein: 31.5% of DM, crude fat: 8.1% of DM, crude fibre: 12.3% of DM). Measurement results are detailed in table 1.

TABLE 1
Daily egg production (pieces) and egg weight
(kg/100 hens) results from the trial

| | | Feed containing treated | |
|---|---|---|---|
| | Control feed | rapeseed grits | |
| | with soy only | Example I | Example 2 |
| Mean number of laying hens | 79.2 ± 0.37 | 79 ± 0.00 | 80 ± 0.00 |
| Mean egg production per day | 62.52 ± 3.48 | 61.78 ± 3.74 | 63.68 ± 3.37 |
| (pieces) | | | |
| Eggs produced per day | 5.29 | 5.19 | 5.37 |
| (kg/100 hens)* | | | |

*Calculated value (egg weight. kg × percent egg production) ×100

### EXAMPLE 3

The following components are measured to a 20 cm³ screw-cap container: 4.5 g calcium nitrate (calcium content: 20%). 1.5 g corn gluten (dry matter: 10%, protein content: 58% of DM) and 1.5 g kaolin (dr) matter >95%, ion-exchange capacity: 0.8 mol/kg). The container containing the mixture is sealed, then shaken for 10 minutes at 22-25° C. on a “HAAKE SWB” 20 type shaker (n=80 min).

150 g extracted rapeseed grits [glucosinate concentration: 27 mmol/kg (expressed as sinigrin): dry matter: 90.5%, crude protein: 35.5% of DM, crude fat: 2.1% of DM, crude fibre: 14.0% of DM) are measured to a 500 cm³ screw-cap container and the previously prepared powder mixture is added thereto. The container containing the mixture is sealed, then shaken for 10 minutes at 22-25° C. on a shaker (n=80/min).

Using the rapeseed grits treated as described above, a swine fattening feed with the following composition is prepared by a method known per se. Ingredients of 1000 g fattening tied for 30-60 kg live weight pigs: corn: 480 g. extracted soybean grits: 130 g. barley: 200 g. treated rapeseed grits: 154 g. feed lime: 13 P, monocalcium phosphate: 11 g, sodium chloride: 4 g, L-lysine HCl: 2 g. D,L-methionine: 1 g. 0.5% fattening premix: 5 g. As a control, a feed prepared with soy (which cost 40% higher than the treated rapeseed grits) is used with the following composition: corn: 423 g. barley: 310 g. soy: 230 g. feed lime: 13 g. monocalcium phosphate: 11 g. sodium chloride: 4 g. L-lysine HCl: 2 g, D,L-methionine: 1 g. 0.5% fattening premix: 5 g. During fattening of Topigs store-pigs (32±3 kg live weight. 50:50 sow to boar ratio) to 70 kg by feeding with the rapeseed-containing teed and the “soy only” feed, respectively, there is no detectable difference (within the error limit of the measurement method) in mortality (4 pigs in each case), meat yield and feed utilization efficiency indexes, despite the fact that the rapeseed-containing feed is cheaper by 5 percent than the control feed, which contained soy only.

TABLE 2
Weight gain and average feed intakeof store-pigs

| | “Soy only” control | Feed containing |
|---|---|---|
| | feed | treated rapeseed |
| Mean number of store-pigs | 390 ± 4 | 400 ± 6 |
| Mean weight gain [kg/pig] | 35.5 ± 3.48 | 35.7 ± 3.74 |
| Mean feed intake (kg/kg of body | 2.59 ± 0.08 | 2.55 ± 0.09 |
| weight)* | | |

### EXAMPLE 4

The following components are measured to a 2 cm³ screw-cap container: 4.5 g calcium chloroacetate (calcium content: 17.5%) and 8.1 g potato-starch (starch content: 96%). The container containing the mixture is sealed, then shaken for 10 minutes at 22-25° C. on a “HAAKE SWB” 20 type shaker (n=80/min).

The following components are measured to a 3.000 cm³ screws-cap container: 330 g corn, 206 g heat. 134 g Protavit Minor (a dairy cow concentrate made by Bábolna Feed Ltd.). 93 g dairy cow complete mix+microelement premix. 224.4 g treated and hot pressed rapeseed grits (glucosinolate concentration: 27 mmol/kg (expressed in sinigrin), dry matter: 92.5%, crude protein: 32.5% of DM, crude fat: 8.1% of DM, crude fibre: 13.5% of DM), and the previously prepared powder mixture is added thereto. The container containing the dairy cow feed mix with the above composition is sealed, then shaken for 10 minutes at 22-250° C. on a shaker (n=80/min).

Using the rapeseed grits treated as described above, a dairy cow forage mix with the following composition is prepared b a method known per se. Ingredients of rape-containing dairy cow forage mix: 330 g corn. 206 g heat, 237 g hot pressed treated rapeseed-grit. 134 g Protavit Minor (a dairy cow concentrate made by Bábolna Feed Ltd.), 93 g dairs cow complete mix+microelement premix. The soy-containing dairy cow forage blend prepared with sor (which costs 40% higher than the trealted rapeseed grits) has the following composition: 330 g corn. 237 g wheat. 206 g extracted soybean grits. 134 g Protait Minor (a dairy cow concentrate). 93 g dairy cow complete mix+microelement premix.

Both groups (Holstein-Friesian breed) where also led with a blend comprised of corn and wheat silage, potato, alfalfa ha) and meadow hal. The cows milked two times a day had a daily feed intake of 10 kg/animal for the forage blend and 34 kg/animal for the other forage components. The composition of milk was measured on a weekly basis individually proportionally with the quantity of the milk in specimens collected from the morning and evening milking.

During the nine week feeding period there were no differences (within the error limit of the measurement method) between the two groups in the mean daily milk production, and in the milk fat content (3.8±0.4 weight %), milk protein content (3.4±0.3 weight %) and lactose content (4.7(0.2 weight %), despite the fact that the rapeseed-containing forage feed was cheaper hi 8 percent on a per unit basis.

TABLE 3
Comparison of milk production of dairy cows fed with forage feeds
containing treated rapeseed and soy, respectively

| | | Feed |
|---|---|---|
| | Soy- | comprising |
| | containing | treated |
| | feed | rapeseed |
| Number of cows per groups | 15 | 15 |
| Number of lactations so far | 2.4 | 2.4 |
| Days from calving | 98 | 101 |
| Mean daily milk production at the | 34.3 | 34.3 |
| beginning of the trial (kg/cow)* | | |
| Mean daily milk production during the | 32.49 ± 4.77 | 33.03 = 4.03 |
| 9 weeks of the trial (kg/cow) | | |

*Based on the mean milk production during a three week period before the beginning of the trial

1. Method for treating rapeseed or a rape product remaining after the partial or complete recovery of the oil content of rapeseed, which method comprise the step of contacting the rapeseed or the rape product or its mixture prepared with one or more other feeds with an intercalation complex of an element belonging to the main group 2 or 3 of the periodic table formed with an anion and one or more polymers.

2. The method of claim 1, wherein the element belonging to the main group 2 or 3 of the periodic table is selected from Al, Ca and Mg.

3. The method of claim 1, wherein the anion is selected from Cl, Br, I, nitrite and nitrate.

4. The method of claim 1, wherein the anion is selected from anions of Formula (I) 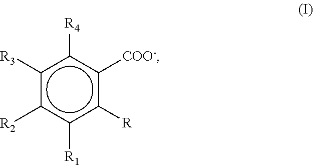
wherein
each of R, R¹, R², R³ and R⁴ independently represents H, OH, SO₃H, NO₂, COOH, halogen, C₁₋₁₀ alkyl, C₁₋₁₀ alkoxy, C₆₋₂₀ aralkoxy optionally substituted with one or more substituents, C₆₋₁₀ aryloxy optionally substituted with one or more substituents, wherein the substituents are individually selected from OH, SO₃H, NO₂, COOH, halogen, C₁₋₁₀ alkyl and C₁₋₁₀ alkoxy.

5. The method of claim 1, wherein the anion is selected from the anions of Formula (II) 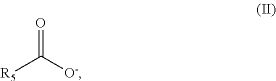
wherein
R⁵ represents H or CR⁶R⁷R⁸, wherein
each of R⁶, R⁷ and R⁸ independently represents H, OH, SO₃H, NO₂, COOH, halogen, C₁₋₂₀ alkyl, C₁₋₂₀ alkoxy, C₆₋₂₀ aralkoxy optionally substituted with one or more substituents, C₆₋₁₀ aryloxy optionally substituted with one or more substituents, wherein the substituents are individually selected from OH, SO₃H, NO₂, COOH, halogen, C₁₋₁₀ alkyl and C₁₋₁₀ alkoxy.

6. The method of claim 1, wherein the anion is selected from anions that can be derived from the following compounds: formic acid, capronic acid, lactic acid, dichloroacetic acid, sulfoacetic acid, oxalic acid, 2-oxoglutaric acid, succinic acid, malic acid, tartaric acid, citric acid, fumaric acid, maleic acid, fumaric acid monoethyl ester, ethyl malonate, phenylacetic acid, (2-chlorophenyl)acetic acid, 2-nitrobenzoic acid, 4-toluenesulfonic acid, 2,6-dichloro-3-nitrobenzoic acid, 2-bromo-5-nitrobenzoic acid, 2-(4-chlorobenzoyl)benzoic acid, 1-naphtalenesulfonic acid, ferulic acid, sinapic acid, gallic acid, trimethoxybenzoic acid, homoveratrumic acid, phthalic acid, terephthalic acid, 4-(trifluoromethyl)phthalic acid, 3-nitrophthalic acid, EDTA.

7. The method of claim 1, wherein the polymer is selected from organic polymers, preferably wheat meal, corn gluten, potato starch, rapeseed grits and alfalfa meal, and from inorganic polymers, preferably aluminum silicate, kaolin and zeolites.

8. The method of claim 1, wherein the contacting is carried out by agitation at ambient temperature.

9. The method of claim 1, wherein the weight ratio of the salt formed by an element belonging to the main group 2 or 3 of the periodic table with an anion to the polymer is from 1/100 to 500/100, preferably from 10/100 to 90/100.

10. The method of claim 1, wherein the weight ratio of the rapeseed or rape product to the intercalation complex is from 1/10000 to 300/1000, preferably from 1/1000 to 50/1000.

11. Rapeseed or rape product, which can be produced by the method of claim 1, or a mixture thereof formed with one or more other feeds.

12. Rapeseed or rape product, which can be produced by the method of claim 1, or a mixture thereof formed with one or more other feeds, for use in animal feeding.

13. Use of the rapeseed or the rape product which can be produced by the method of claim 1, or of a mixture thereof formed with one or more other feeds in animal feeding.

14. The use of claim 13, wherein the rapeseed or the rape product is used alone or admixed with animal feeds and optionally with premixes and/or supplements.

15. Animal feed comprising rapeseed or rape product, which can be produced by the method of claim 1, or a mixture thereof formed with one or more other feeds alone or admixed with animal feeds and optionally with premixes and/or supplements.

16. A method for improving animal nutrition, said method comprising feeding to an animal rapeseed or rape product produced by the method of claim 1.

17. The method of claim 3, wherein the element belonging to the main group 2 or 3 of the periodic table is selected from Al, Ca and Mg.

18. The method of claim 6, wherein the element belonging to the main group 2 or 3 of the periodic table is selected from Al, Ca and Mg.
